(19) United States
(12) Patent Application Publication
(10) Pub. No.: US 2011/0020723 A1
(43) Pub. Date: Jan. 27, 2011

(54) FUEL CELL PLATE HAVING MULTI-DIRECTIONAL FLOW FIELD

(75) Inventor: Tommy Skiba, East Hartford, CT (US)

Correspondence Address: CARLSON, GASKEY & OLDS, P.C., 400 WEST MAPLE ROAD, SUITE 350, BIRMINGHAM, MI, 48009, US

(73) Assignee: UTC POWER CORPORATION, South Windsor, CT (US)

(21) Appl. No.: 12/922,767

(22) PCT Filed: Apr. 4, 2008
(86) PCT No.: PCT/US2008/059351

§ 371 Date: Sep. 15, 2010

(51) Int. Cl. H01M 8/04

(52) U.S. Cl. 429/450; 429/514

(57) ABSTRACT

An exemplary fuel cell plate includes a plurality of first flow field channels that have an inlet near one end and an outlet near an opposite end. The first flow field channels establish a plurality of first fluid flow paths from a corresponding inlet to the corresponding outlet. A plurality of second flow field channels have an inlet near one end and an outlet near an opposite end for establishing a plurality of second fluid flow paths from the inlet to the outlet. The direction of fluid flow in the first fluid flow paths is opposite to a direction of fluid flow in the second fluid flow paths. At least some of the second flow field channels are between two of the first flow field channels.

### BACKGROUND

Fuel cells are used for generating electricity based on an electrochemical reaction fuel cells. Some fuel cell arrangements include solid plates that introduce water management challenges. For example, solid plates are often used for establishing reactant flow fields. Gases entering the flow fields are usually dry, which tends to cause dry out near the fuel cell inlet. A dry out condition can reduce fuel cell performance and can shorten the useful life of the fuel cell.

On the other hand, as the gases travel along the flow field, there tends to be an increased amount of moisture entrained in the gas flow. Consequently, there is a possibility for flooding the outlet side because of the build up of moisture associated with the exiting gases. Excessive moisture at the outlet reduces fuel cell performance.

### SUMMARY

An exemplary fuel cell plate includes a plurality of first flow field channels that have an inlet near one end and an outlet near an opposite end. The first flow field channels establish a plurality of first fluid flow paths from a corresponding inlet to the corresponding outlet. A plurality of second flow field channels have an inlet near one end and an outlet near an opposite end for establishing a plurality of second fluid flow paths from the inlet to the outlet. The direction of fluid flow in the first fluid flow paths is opposite to a direction of fluid flow in the second fluid flow paths. At least some of the second flow field channels are between two of the first flow field channels.

An exemplary method of managing moisture distribution along a fuel cell plate includes orienting a flow direction through a plurality of first flow field channels in a first direction. A flow direction through a plurality of second flow field channels is oriented in an opposite direction from the first direction. At least some of the second flow field channels are between two of the first flow field channels.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates an example fuel cell plate.

FIG. 2 schematically illustrates another example fuel cell plate.

### DETAILED DESCRIPTION

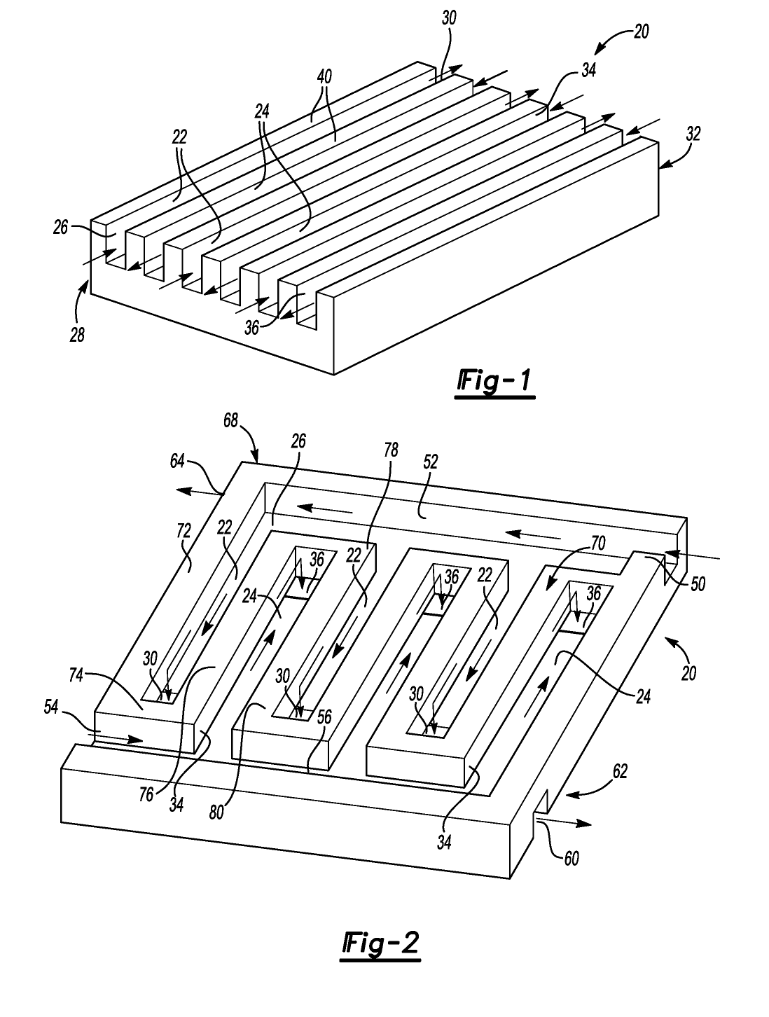

FIG. 1 schematically shows a fuel cell plate 20, which in this example is a solid plate. The example plate 20 includes a uniquely arranged flow field. A plurality of first flow field channels 22 establish a plurality of first fluid flow paths. A second plurality of flow field channels 24 establish a second plurality of fluid flow paths.

The plurality of first flow field channels 22 each have an inlet 26 near one end 28 of the plate 20. Each of the plurality of first flow field channels 22 have an outlet 30 near an opposite end 32 of the plate 20.

Each of the second flow field channels 24 have an inlet 34 near the end 32 of the plate 20. An outlet 36 of each of the second flow field channels 24 is near the end 28 of the plate 20.

Having inlets and outlets arranged as schematically shown in FIG. 1 provides a plurality of fluid flow paths in one direction through the first flow field channels 22 and a plurality of fluid flow paths in an opposite direction through the second flow field channels 24. The arrows in the illustration represent the direction of fluid flow.

As the gases within the fluid flow paths are typically drier at an inlet and contain more moisture near an outlet, the illustrated configuration facilitates more uniform water distribution along the plate 20. The same fluid (e.g., air or a fuel gas) flows through the first and second channels 22 and 24 in some examples.

In the illustrated example, the opposite directions of fluid flow in adjacent fluid flow paths or flow field channels allows for water transfer across ribs 40 that separate the channels. In one example, water transfer occurs across an end (e.g., the top in the illustration) of the ribs 40.

The opposite direction of fluid flow in the illustrated example provides a relatively dry inlet gas near a relatively wet outlet gas, which facilitates better water distribution and a resulting increased performance and useful service life for the plate 20. The illustrated arrangement also allows for operating with relatively lower humidity levels because the tendency for a portion of the plate 20 to dry out is minimized or eliminated by the strategic arrangement of the fluid flow directions through the channels 22 and 24.

FIG. 2 schematically illustrates another example plate 20 having the plurality of first flow field channels 22 providing a fluid flow direction that is opposite to a fluid flow direction through the second plurality of flow field channels 24. In this example, like the example of FIG. 1, the first flow field channels 22 are interdigitated with the second flow field channels. In these examples, every flow field channel has an adjacent flow field channel that provides an opposite fluid flow direction. Other examples include at least two first flow field channels 22 adjacent each other without any second flow field channel 24 between them. At least some of the first flow field channels 22 have a second flow field channel 24 between them.

In the example of FIG. 2, the first flow field channels 20 receive an inlet gas provided at an inlet 50 through an inlet passage 52. In this example, one end of each of the first flow field channels 22 is an inlet end 26 in communication with the common inlet passage 52. Similarly, the second flow field channels 24 have one end as the inlet end 34 that receive gas provided at an inlet 54 through a common inlet channel 56. As can be appreciated from the illustration, the common inlet channels 52 and 56 are transverse to the direction of fluid flow through the flow field channels. The common inlet channels 52 and 56 are located near opposite ends of the plate 20.

The outlets 30 of the first flow field channels 22 direct the outlet gases, which tend to be higher in moisture content, through a common outlet passage 60. In this example, the outlet passage 60 is open toward one side 62 of the plate 20. The outlets 36 of the second flow field channels 24 direct the gases flowing in the second fluid flow direction through a common outlet passage 64. In this example, the outlet passage 64 is open toward the one side 62 of the plate 20.

In FIG. 2, each of the first flow field channels 22 and each of the second flow field channels 24 are open toward a side 68 of the plate 20 that is facing in an opposite direction compared to the side 62 toward which the outlet passages 60 and 64 are open. The same fluid flows in the first and second channels 22 and 24 in some examples.

The arrangement of FIG. 2 includes a rib design 70 that separates the first flow field channels 22 from the second flow field channels 24 and facilitates access to the common inlet passages 52 and 56. The example rib 70 includes a first section 72 along one side of the one of the first flow field channels 22. A second section 74 is transverse to the first section 72. In the illustrated example, the second section 74 is at least partially perpendicular to at least a portion of the first section 72. In this example, the second section 74 is adjacent the outlet 30 of the corresponding first flow channel 22. A third section 76 is generally parallel to the first section 72. The third section 76 is along a side of the first flow field channel 22 opposite from the first section 72 such that the first section 72 and the third section 76 establish or define a width of the corresponding first flow field channel 22.

The illustrated third section 76 is along one side of a second flow field channel 24. A fourth section 78 of the rib 70 is transverse to the third section 76. The fourth section 78 is near the outlet 36 of the corresponding second flow field channel 24. A fifth section 80 is generally parallel to the third section 76 and establishes an opposite side of the corresponding second flow field channel 24.

The rib 70 has a repeated configuration across the plate 20 as can be appreciated from the illustration. The number of sections used depends upon the number of flow field channels desired for a particular plate. Only a few flow field channels are shown for discussion purposes. A typical plate 20 will include more channels than shown in the illustration.

One technique of making the example plate 20 includes molding the flow field channels, the common inlet channels and the common outlet channels as a part of the plate 20 during a molding process. Another example includes machining a piece of plate stock to achieve the desired channel configuration. Another example includes molding a portion of the channels and machining a remaining portion.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-10. (canceled)

11. A fuel cell plate, comprising:
a plurality of first flow field channels having an inlet near one end and an outlet near an opposite end for establishing a plurality of first fluid flow paths from the inlet to the outlet;
a plurality of second flow field channels having an inlet near one end and an outlet near an opposite end for establishing a plurality of second flow fluid paths from the inlet to the outlet, wherein the first fluid flow paths are in an opposite direction relative to the second fluid flow paths and at least some of the second flow field channels are between two of the first flow field channels and the flow field channels are open toward one side of the plate along a length of the flow field channels and the outlet of each channel directs fluid flow toward an opposite side of the plate.

12. The fuel cell plate of claim 11, wherein the first flow field channel inlets are near one end of the plate and the second flow field channel outlets are near the one end of the plate.

13. The fuel cell plate of claim 12, wherein the first flow field channel outlets are near an opposite end of the plate and the second flow field channel inlets are near the opposite end.

14. The fuel cell plate of claim 11, wherein the second flow field channels are interdigitated with the first flow field channels such that every other fluid flow path is in an opposite direction compared to an adjacent fluid flow path.

15. The fuel cell plate of claim 11, comprising a hole in the plate in communication with the outlets.

16. The fuel cell plate of claim 11, comprising an outlet flow passage in communication with at least one of the plurality of flow field channel outlets, the outlet flow passage being open toward the opposite side of the plate.

17. The fuel cell plate of claim 11, wherein the inlets of the first flow field channels are adjacent the outlets of the second flow field channels and the inlets of the second flow field channels are adjacent the outlets of the first flow field channels.

18. A method of managing moisture distribution along a fuel cell plate, comprising the steps of:
orienting a flow direction through a plurality of first flow field channels in a first direction;
orienting a flow direction in a second, opposite direction through a plurality of second flow field channels, wherein at least some of the second flow field channels are between two of the first flow field channels;
establishing the flow field channels on one side of the plate; and
arranging an outlet of each flow field channel to direct fluid exiting the corresponding flow field channel toward an oppositely facing side of the plate.

19. The method of claim 18, comprising
positioning inlets of the first flow field channels adjacent outlets of the second flow field channel; and
positioning inlets of the second flow field channels adjacent outlets of the first flow field channels.

20. The method of claim 18, comprising
providing a hole in the plate; and
directing flow through the hole.
